(19) United States
(12) Patent Application Publication
(10) Pub. No.: US 2022/0161819 A1
(43) Pub. Date: May 26, 2022

(54) AUTOMATIC MOTOR-VEHICLE DRIVING SPEED CONTROL BASED ON DRIVER'S DRIVING BEHAVIOUR

(71) Applicant: C.R.F. SOCIETA' CONSORTILE PER AZIONI, Orbassano (TO) (IT)

(72) Inventors: Roberto FEDELI, Orbassano (TO) (IT); Enrico RAFFONE, Orbassano (TO) (IT); Claudio REI, Orbassano (TO) (IT); Massimo FOSSANETTI, Orbassano (TO) (IT)

(73) Assignee: C.R.F. SOCIETA' CONSORTILE PER AZIONI, Orbassano (TO) (IT)

(21) Appl. No.: 17/441,957

(22) PCT Filed: Mar. 27, 2020
(86) PCT No.: PCT/IB2020/052948

§ 371 Date: Sep. 22, 2021

(30) Foreign Application Priority Data
Mar. 29, 2019 (IT) 102019000004795

(51) Int. Cl. B60W 60/00; B60W 30/14

(52) U.S. Cl. CPC B60W 60/0013; B60W 30/143; B60W 2720/10; B60W 2540/30; B60W 2556/10; B60W 2520/10

(57) ABSTRACT

An automotive electronic driving speed control system configured to control the driving speed of the motor-vehicle along a recurring path travelled by the motor-vehicle in assisted- or autonomous-driving based on one or more driver-specific driving speed profiles of the motor-vehicle learnt during one or more previous travels of the same path along which the motor-vehicle is manually driven by the specific driver.

### CROSS REFERENCE TO RELATED PATENT APPLICATIONS

This patent application claims priority of Italian patent application No. 102019000004795 filed on 29 Mar. 2019, the entire content of which is incorporated herein by reference.

### TECHNICAL FIELD OF THE INVENTION

The present invention relates in general to motor-vehicle driving assistance, and in particular to automatic motor-vehicle driving speed control based on driver's driving behavior.

The present invention finds application in any type of road motor-vehicles, both those used for transporting people, such as cars, buses, campervans, etc., and those used for transporting goods, such as industrial motor-vehicles (trucks, trailer trucks, articulated motor-vehicles, etc.) and light and medium/heavy commercial motor-vehicles (vans, van bodies, chassis-cabs, etc.).

### STATE OF THE ART

As is known, in recent years car manufacturers have invested considerable resources in the research for Advanced Driver Assistance Systems (ADAS) for improving driving safety and comfort.

For this reason and for the fact that they will help achieve the objectives on reduction of road accidents set by the European Union, ADAS are one of the fastest growing segments in the automotive sector and are destined to become increasingly popular in the coming years.

The safety features of the ADAS are designed to avoid collisions and accidents, by offering technologies that warn drivers of potential problems, or to avoid collisions by implementing safeguard measures and taking control of the motor-vehicles. Adaptive features can automate lighting, provide adaptive cruise control, automate braking, incorporate GPS/traffic alerts, connect smartphones, alert drivers of other motor-vehicles to hazards, keep drivers in the correct lane, or show them what there is in blind spots.

ADAS technology is based on vision/camera systems, sensor systems, automotive data networks, Vehicle-to-Vehicle (V2V) or Vehicle-to-Infrastructure (V2I) communication systems. Next-generation ADAS systems will increasingly exploit wireless connectivity to offer added value to V2V and V2I communication.

Technological developments such as integration of radars and cameras, and fusion of sensors between multiple applications, are expected to result in a cost reduction which could lead to a more significant penetration of ADAS in the compact vehicle market.

The end point of these technological developments is usually defined as self-driving or driverless motor-vehicles, or autonomous motor-vehicles. The two terms are in the vast majority of times used indifferently, as in the present discussion, while in some specialized environments these two terms are instead used differently to make subtle distinctions.

In particular, the term autonomous motor-vehicles has been used to indicate those vehicles that resemble today's ones, i.e., with the seats facing forward and the steering wheel, and in which the driver is exempt from driving tasks only in certain circumstances, for example to perform an autonomous parking or automatic braking, or to implement an Adaptive Cruise Control designed to control the speed of the motor-vehicle in order to keep a safe distance from cars ahead. In the near future, autonomous motor-vehicles could take full control of driving in heavy traffic or on motorways.

The term self-driving motor-vehicles was instead used to indicate those motor-vehicles that are instead considered to represent a step forward compared to autonomous motor-vehicles, i.e., motor-vehicles in which the steering wheel will disappear completely and the motor-vehicles will make the whole journey using the same sensory system used by autonomous motor-vehicles.

Disregarding this subtle distinction, the real distinction is between assisted driving motor-vehicles, where the vehicle “assists” the driver (who is therefore not exempt from paying attention), by braking if the motor-vehicle ahead brakes, slowing down when there is a need, and so on, and automatic or automated driving motor-vehicles, where, unlike the previous one, the motor-vehicle is completely autonomous in driving and the driver may not pay attention.

An example of this terminological distinction is represented in the article by Wood et al., (2012), in which the author writes: “This article often uses the term autonomous instead of automated. The term “autonomous” was chosen “because it is currently the most commonly used term (and most familiar to the general public). However, the term “automated” is certainly more accurate because it connotes the control or actions performed by the machine, while “autonomous” implies acting alone and independently. Currently, most vehicles (which are not aware of having a person on the seat), use communication with the Cloud, or with other vehicles, and do not enter the destination independently. This is why the term “automated” would be better to describe this vehicle concept.”.

In 2014, SAE (Society of Automotive Engineers) International, a standardization body in the field of aerospace, automotive and vehicle industries that deals with developing and defining the engineering standards for motorized vehicles of all kinds, including cars, trucks, ships and aircraft, released a new international standard, J3016, which defined six different levels for automated driving. This classification is based on how much the driver has to intervene on the motor-vehicle, rather than on the motor-vehicle's capabilities.

The six levels of automated driving are:

Level 0—No Automation: The driver must take care of every aspect of driving, without any type of electronic support;

Level 1—Driver Assistance: The driver must take care of every aspect of driving, but he is supported at an informative level (in the form of visual or acoustic alerts) by electronic systems that can indicate the presence of dangerous situations or adverse conditions. At this level, the motor-vehicle is limited to analyzing and representing situations, but the driver has total and full responsibility for driving the vehicle;

Level 2—Partial Automation: The driver takes care of driving, but there is an initial driving integration. At this level, the motor-vehicle intervenes on acceleration and braking through safety systems, such as assisted braking, anti-collision emergency braking. Direction and traffic control remain under the control of the driver, although the steering may be managed in a partially automated manner in certain scenarios with clearly visible horizontal signs (systems named Lane Keeping Assist and, in the more complete versions, Traffic Jam Assist, Autosteer, Highway Assist depending on the motor-vehicle brand);

Level 3—Conditional Automation: The motor-vehicle is able to manage driving in ordinary environmental conditions, managing acceleration, braking and direction, while the driver intervenes in problematic situations in the event of a system request or if the driver himself verifies adverse conditions;

Level 4—High Automation: The automatic system is able to manage any eventuality, but it should not be activated in extreme driving conditions such as in bad weather;

Level 5—Full Automation: The automatic driving system is able to manage all situations that can be managed by a human being, without any human intervention.

With reference to one of the aforementioned ADAS systems, i.e., the automotive electronic cruise control system, as is known, it is designed to automatically adjust and keep a speed selected by the driver.

There are two types of automotive electronic cruise control systems: one known as Non-Adaptive Cruise Control (CC) or Tempomat, and one known as Adaptive Cruise Control (ACC).

The Non-Adaptive Cruise Control (CC) is designed to keep only the speed set by the driver, who can choose to increase or decrease it by operating control buttons on the steering wheel or a special lever on the steering wheel switch. In addition, the driver can overtake another motor-vehicle, press the accelerator pedal and increase the speed, which will return to the previously set speed only when the acceleration is stopped.

The Adaptive Cruise Control (ACC) on the other hand, is designed to act in a combined way on the motor-vehicle's engine and braking system in order to accelerate and decelerate the motor-vehicle to bring and keep it at a cruise speed or a cruise distance that can be set and adjusted by the driver.

A common feature of the two systems is deactivation in the event of pressure of the brake pedal, the clutch, the handbrake, activation of a safety system (VDC, ASR etc.) or failure of electrical circuits.

In greater detail, FIG. 1 shows a principle functional block diagram of the operations implemented by an automotive Electronic Control Unit (ECU) to perform the ACC function according to the prior art.

As shown in FIG. 1, the ACC function according to the prior art operates based on various input quantities, including the current speed of the host motor-vehicle, a cruise speed of the host motor-vehicle that can be set by the driver, the current speed and relative distance of the host motor-vehicle with respect to a motor-vehicle ahead, and the cruise distance of the host motor-vehicle with respect to a motor-vehicle ahead that can be set by the driver through the setting of the so-called HeadWay Time, that in fact represents, in terms of time rather than distance, the cruise distance that the driver of the host motor-vehicle wishes to keep with respect to the motor-vehicle ahead and that cannot be less than a given value representative of the safety distance, which, as is known, depends on the current speed of the host motor-vehicle and the average response time of the driver of the host motor-vehicle.

HeadWay Time is generally selectable by the driver of the host motor-vehicle in a range of stored values which result in a greater or lesser cruise distance of the host motor-vehicle with respect to a motor-vehicle ahead. In general, a value of two seconds is generally considered sufficient to prevent a collision (rear-end collision) with the motor-vehicle ahead for most drivers.

As shown in FIG. 1, the ACC function is designed to operate in two different modes, a cruise mode, where the current speed of the host motor-vehicle is controlled so as to keep a cruise speed set by the driver, and a follow mode, where the current speed of the host motor-vehicle is controlled in order to maintain a cruise distance set by the driver relative to a motor-vehicle ahead.

To operate in the manner described above, the ACC function is designed to implement independent speed and distance controls selectable by a control logic designed to cause the switching from the cruise mode to the follow mode in response to the detection of a motor-vehicle ahead below a predetermined distance from the host motor-vehicle, and the return to the cruise mode in response to the detection of no motor-vehicle ahead below the predetermined distance from the host motor-vehicle.

In the two operating modes described above, the ACC function operates based on control quantities or parameters, which include, inter alia, cruise speed and distance, as well as an acceleration/deceleration profile to be performed by the host motor-vehicle to keep the cruise speed and distance, and are suitable to take, under normal operating conditions, nominal values that can be set by the driver, such as those for cruise speed and distance, or predetermined and stored in the ECU, such as those for the acceleration/deceleration profile, or even computed based thereon.

FIG. 2 shows instead more detailed functional block diagrams of the speed and distance controls, which operate in a closed loop based on an error between a current value and a reference value of the controlled parameter (speed or distance) in order to eliminate the error between the two values and thus ensure that the current value faithfully follows the reference value.

Unlike the ACC function, the CC functionality is designed to operate in the cruise mode only, where the current speed of the motor-vehicle is controlled in order to keep a cruise speed set by the driver.

EP 2 886 410 A1 describes a host motor-vehicle speed control device, comprising a processing unit configured to compare the position of the host motor-vehicle with data representative of geographic road segments contained in a database to determine a current geographic road segment, and process historical speed profiles associated with the current geographic road segment to generate a speed control signal of the host motor-vehicle. The host motor-vehicle speed control device further comprises a speed controller to control the speed of the host motor-vehicle based on the generated host motor-vehicle speed control signal.

DE 10 2010 054 077 A1 describes a method and a driver assistance system for providing driving recommendations to the driver of a motor-vehicle based on an optimized speed profile and the current position of the motor-vehicle. The system provides for recovering a set of speed profiles for a driving section in front of a motor-vehicle, wherein each speed profile shows a progression of the speed of the motor-vehicle along the driving section. The most likely speed profile for the driving section is determined based on the set of speed profiles. An optimized speed profile is determined based on the most likely speed profile and a predetermined optimization parameter. A driving recommendation is then provided based on the optimized speed profile and the current position of the car. The speed profile consists of data relating to speed and position of the motor-vehicle.

US 2011/313647 A1 relates to the management of a motor-vehicle aimed at optimizing the energy consumption based on a management logic for the power supplied by the engine of the motor-vehicle based on information supplied from outside the motor-vehicle, the operational status of the motor-vehicle, one or more controls of the driver of the motor-vehicle and one or more operating parameters of the motor-vehicle.

GB 2 539 676 A describes a method of controlling the speed of a motor-vehicle in response to information on the path of the motor-vehicle. A section of the planned path is identified based on the planned path data provided by a navigation system and/or a recurring path register. A braking or acceleration point along the intended route is determined based on the path and, optionally, taking into account the obstacles detected by a sensor or real-time information obtained by a unit. Preferably, speed profiles of the motor-vehicle are recorded in a register of recurring paths in association with corresponding paths and used to determine the optimal braking or acceleration point. Typically, the time of day or the day of the week can also be recorded and taken into account. The optimum braking or acceleration point can be transmitted to the driver in the form of a signal, typically a visual, audible or tactile signal, or it can be used to adjust the speed profile.

### OBJECT AND SUMMARY OF THE INVENTION

The Applicant has ascertained that the prior art CC and ACC functions, although satisfactory in many respects, have a margin of improvement at least in terms of the behavior in controlling the driving speed of the motor-vehicles, which can sometimes be so different from the drivers' driving behaviors as to be little congenial to the drivers and, consequently, to give rise to unpleasant driving experiences or comforts.

The Applicant has also ascertained that the problem also occurs in automated driving vehicles under development, where automated driving systems are developed based on principles and logics that can equally give rise to driving experiences or comfort little congenial to drivers.

Therefore, the present invention aims to improve the behaviors of the CC and ACC functions and of the automated driving systems so as to adapt them to drivers' driving behaviors and make them more familiar to drivers, thus improving the driving experience or comfort.

According to the present invention, an automotive electronic driving speed control system for a motor-vehicle, as claimed in the appended claims.

### BRIEF DESCRIPTION OF THE DRAWINGS

FIGS. 1 and 2 show functional block diagrams of operations performed by an automotive electronic control unit to implement a prior art ACC function.

FIG. 3 shows a block diagram of a motor-vehicle equipped with an automotive cruise control system according to the present invention.

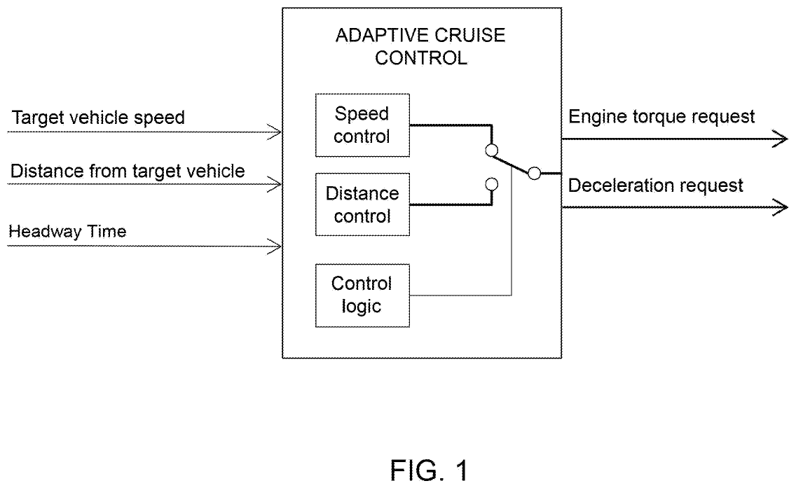

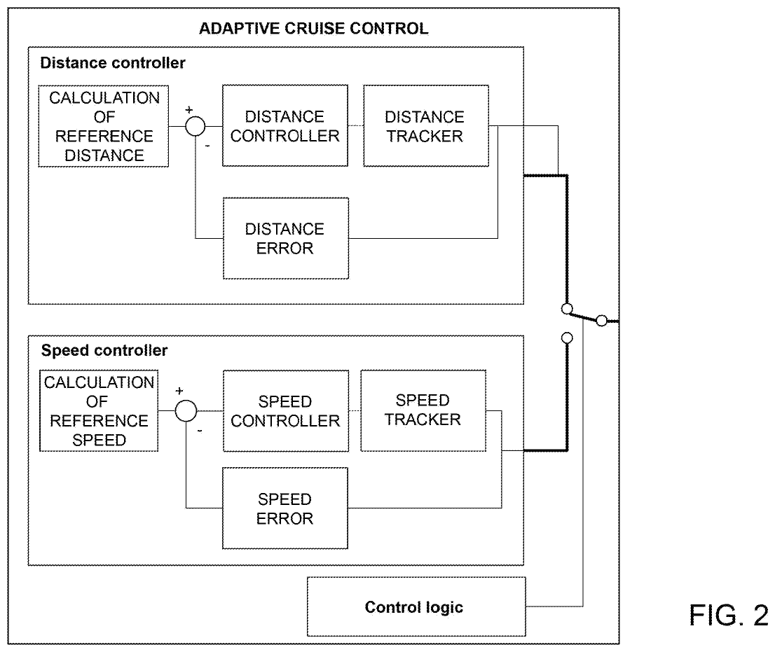

### DETAILED DESCRIPTION OF PREFERRED EMBODIMENTS OF THE INVENTION

The present invention will now be described in detail with reference to the attached figure to enable an expert in the field to embody it and use it. Various modifications to the described embodiments will be readily apparent to experts in the field, and the generic principles described herein can be applied to other embodiments and applications without departing from the scope of the present invention, as defined in the appended claims. Thus, the present invention should not be considered as limited to the embodiments set forth herein, but is to be accorded the widest scope consistent with the principles and features disclosed and claimed herein.

Unless otherwise defined, all the technical and scientific terms used herein have the same meaning commonly used by those of ordinary skill in the field pertaining to the present invention. In case of conflict, the present disclosure, including the definitions provided, will be binding. Furthermore, the examples are provided for illustrative purposes only, and as such they should not be considered limiting.

In particular, the block diagrams included in the attached figures and described below are not to be intended as a representation of the structural features, or constructive limitations, but should be interpreted as a representation of functional features, i.e. intrinsic properties of the devices and defined by effects obtained, or functional limitations, and that can be implemented in different ways, therefore so as to protect the functionality of the same (possibility of functioning).

In order to facilitate the understanding of the embodiments described herein, reference will be made to some specific embodiments and a specific language will be used to describe them. The terminology used in this document has the aim to describe particular embodiments only and is not intended to limit the scope of the present invention.

Furthermore, for descriptive simplicity, the present invention will be described with reference to CC and ACC functionalities only, without however losing in general scope, and it is however intended that what is said regarding CC and ACC functionalities is also valid for automated driving systems.

Broadly speaking, one aspect of the present invention essentially involves modifying the paradigm on which the prior art CC and ACC functions are based, so that, in the cruise mode, the driving speed of a motor-vehicle may be automatically controlled along a recurring path or route of the motor-vehicle based on one or more driver-specific cruise speed profiles learnt during one or more previous travels of the same path along which the motor-vehicle is manually driven by the specific driver, in addition or as an alternative to automatically controlling the driving speed of the motor-vehicle based on cruise speeds settable by the driver of the motor-vehicle by means of control buttons on the steering wheel or a lever located in the steering wheel switch of the motor-vehicle.

To learn a driver-specific cruise speed profile of the motor-vehicle, the present invention firstly provides for recognizing a recurring route along which the motor-vehicle is manually driven by the specific driver, such as, for example, a daily home-to-work or home-to-school-to-work trip or commute, and vice versa; then storing, at a series of individual geographical positions along a recognized recurring path, path data including, inter alia, speed data indicating motor-vehicle speeds at these geographical positions; and then creating the driver-specific cruise speed profile along the recurring path of the motor-vehicle based on the motor-vehicle speeds stored at these geographical positions.

The driver-specific cruise speed profile thus created is then used by the CC or ACC function to automatically control the driving speed of the motor-vehicle along the recurring path, thereby causing the driving speed of the motor-vehicle to follow or reproduce driver-specific the cruise speed profile learnt during one or more previous travel of the recurring path along which the motor-vehicle is driven.

This results in the behavior of the CC and ACC functions during the automatic driving speed control being close to the driving behaviors of the drivers of the motor-vehicles, thus improving the driving experience or comfort.

According to a further aspect of the present invention, recurring paths or routes of the motor-vehicle are recognized, and corresponding cruise speed profiles along the recurring paths or routes of the motor-vehicle are learnt, by a user terminal present on board the motor-vehicle, for example the driver's smartphone, which is configured to recognize if the current path of the motor-vehicle is one of the recurring paths of the motor-vehicle and, if so, to communicate with the ECU of the motor-vehicle that implement the CC and ACC functions to provide it with the learnt cruise speed profile or, alternatively, one after the other the individual cruise speeds that form the learnt cruise speed profile and based on which the CC and ACC functions will then automatically control the speed of the motor-vehicle along the recurring path of the motor-vehicle.

In this way, the cruise speed profiles that the CC and ACC functions follow along the recurring paths of the motor-vehicles are computed by exploiting computational and storage resources of user terminals of the drivers, without thus exploiting automotive ECU resources.

In a different embodiment, recognition of recurrent paths or routes and learning of speed profiles along identified recurrent paths or routes are operations performed on board the motor-vehicle, exploiting computational and storage resources of the motor-vehicle, without thus requiring involvement of user terminals and, therefore, allowing implementation of the CC and ACC functions according to the present invention even in the absence of user terminals on board the motor-vehicles or in the presence of user terminals on board the motor-vehicles with insufficient computational and storage resources to recognize recurrent paths or routes and learn speed profiles along identified recurrent paths or routes.

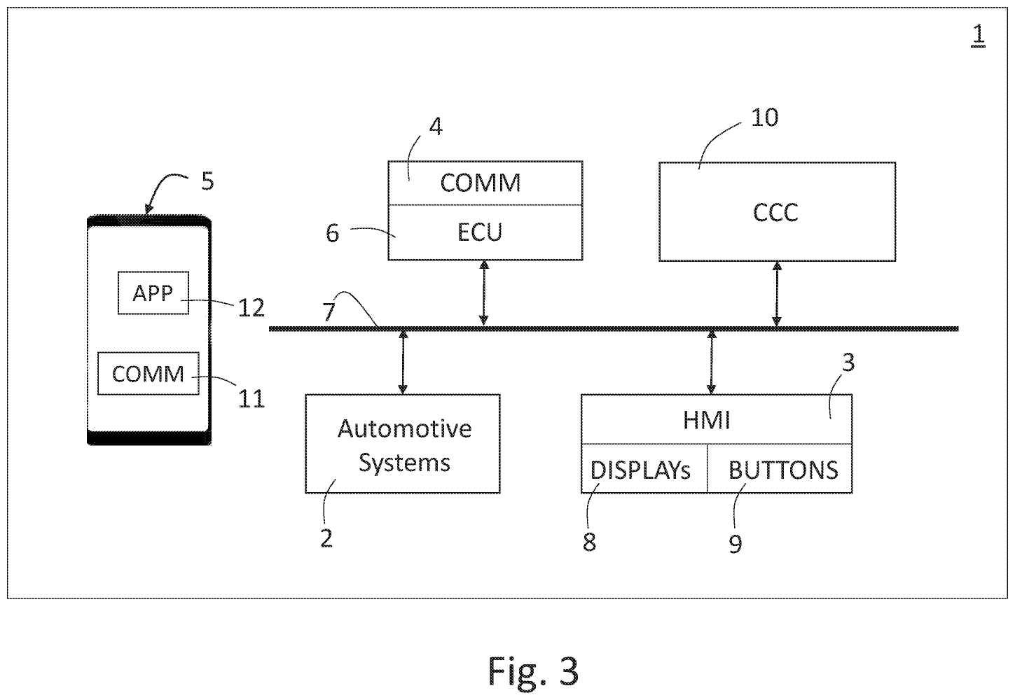

FIG. 3 shows a block diagram of a motor-vehicle 1 equipped with an automotive electronic speed control system 1 according to the first embodiment of the invention, i.e., the one involving a user terminal present on board the motor-vehicle.

It goes without saying that in the second embodiment described above, i.e., the one where no user terminal on board the motor-vehicle is involved, the operations that will be described below as performed by the user terminal are to be intended as performed by computational and storage resources of the motor-vehicle.

As shown in FIG. 3, motor-vehicle 1 comprises:
automotive systems 2 comprising, inter alia, a propulsion system, a braking system, and a sensory system suitable for detecting physical motor-vehicle-related quantities, such as, for example, wheel angle, steering wheel angle, yaw rotation, longitudinal and lateral accelerations, longitudinal speed, geographical position, presence of obstacles in front of the motor-vehicle 1, etc.,
an automotive user interface 3 (Human-Machine Interface—HMI) through which users can interact with automotive systems 2, such as the air conditioning system, the infotainment system, etc.,
an automotive communication interface 4, and
processing and storage resources designed and programmed to control operation of automotive systems 2 and automotive user interface 3 and to store and execute a software comprising instructions which, when executed, cause the processing and storage resources to become configured to communicate and cooperate with a user terminal 5 on board the motor-vehicle 1, and with automotive systems 2, in particular the propulsion braking systems, to implement an automotive electronic speed control system 1 providing the CC or ACC function according to the present invention, that will be described in detail below and will be called Cooperative Cruise Control (CCC).

For the purposes of implementing the Cooperative Cruise Control, it is emphasized that what matters are the operations that must be carried out to implement the Cooperative Cruise Control function, and not the hardware architecture adopted to reduce it to practice, to the extent that the operation described could all be carried out by the same automotive electronic control unit or distributed among different automotive electronic control units, depending on the hardware architecture that the automotive manufacturer will deem appropriate for the implementation of the Cooperative Cruise Control.

For this reason, and also for ease of description, and without this in any way being considered as limiting to the hardware architecture shown, by way of example only, in FIG. 3 the processing and storage resources used for implementing the Cooperative Cruise Control are generally illustrated in the form of a single automotive electronic control unit (ECU) 6, which can be electrically connected to other electronic control units of the automotive systems 2 and of the automotive user interface 3 through an automotive on-board communication network 7, for example (C-)CAN, FlexRAy or others, and which can be suitably designed and programmed to directly or indirectly control operation of the automotive systems 2 and of the automotive user interface 3 for the implementation of the Cooperative Cruise Control.

The automotive user interface 3 comprises:
one or more electronic displays 8, one or more of which, for example, are touch-sensitive displays, and on one or more of which icons can be displayed, which are user-selectable by touch or special soft buttons and relate to automotive functions related to operation of automotive on-board systems, such as entertainment system, air conditioning system, satellite navigation system, etc., and
function selection and activation buttons 9, some of the hard type, located in various points of the passenger compartment of the motor-vehicle 1, including on the steering wheel, in the central console, in the molding, close to the instrument panel and the gear lever, and others of the soft type, i.e., displayed on the electronic displays, and
a software application (APP) developed by the automotive manufacturer to allow, once downloaded, installed, and appropriately set up on their personal user terminals 5, users to interact with some automotive systems 2, such as the infotainment system, through their personal user terminals 5.

The automotive communication interface 4 comprises one or more of:
a bidirectional wired communication system, conveniently the standard serial communication system known as the USB (Universal Serial Bus) interface, which, as is known, comprise special connectors, known as USB connectors or ports, which can be connected to other USB connectors through special cables known as USB cables;
a short-range bidirectional wireless communication system, hereinafter abbreviated to V2D (acronym for Vehicle-to-Device) communication system, operable to automatically detect short-range bidirectional wireless communication systems, hereinafter abbreviated with D2V (acronym for Device-to-Vehicle) communication system, of user terminals 5 in its communication range and to communicate with D2V communication systems detected and identified within its communication range, possibly following an appropriate pairing procedure, if provided for by the communication technology implemented; and
a long-range bidirectional wireless communication system, hereinafter abbreviated for convenience in V2X (acronym for Vehicle-to-Infrastructure) communication system, operable to communicate with a remote service center.

V2D and D2V communication systems are configured to communicate through one or different short-range communication technologies, conveniently including Bluetooth technology, such as the one according to the 4.0 specification and also known as Bluetooth Low Energy, Bluetooth LE or Bluetooth Smart, NFC technology, and Wi-Fi technology.

The V2X communication system is configured to communicate through one or different long-range communication technologies, conveniently including present and future cellular communication technologies, such as, 2G, 3G, 4G, 5G, etc.

ECU 6 is designed to store and execute a software comprising instructions which, when executed, cause ECU 6 to become configured to communicate and cooperate, through communication interface 4, with user terminals 5 on board the motor-vehicle 1, and with automotive systems 2, in particular with the propulsion and braking systems, to implement an automotive electronic driving speed control system, which is schematically shown in FIG. 3 and indicated as a whole with reference numeral 10 and is designed to implement the Cooperative Cruise Control of the present invention.

User terminals 5 can consist of any hand-held or wearable mobile personal electronic communication devices, such as a smartphone, a phablet, a tablet, a personal computer, a smartwatch, etc., equipped with a microprocessor and associated memory capable of providing sufficient processing and storage capacity to compute and store data, hereinafter referred to as Cruise Control data, necessary for implementation of the Cooperative Cruise Control, better described in detail below, as well as with a satellite geolocation device (GPS, Galileo, etc.) capable of providing geolocation data, typically in the form of geographical coordinates (longitude and latitude and height above sea level), and with a communication interface 11 similar to the automotive communication interface 4, i.e., comprising a bidirectional wired communication system, a short-range bidirectional wireless communication system, hereinafter for convenience abbreviated to D2V (acronym for Device-to-Vehicle) communication system, and a long-range bidirectional wireless communication system, hereinafter for convenience abbreviated to D2X (acronym for Device-to-Infrastructure) communication system.

For implementation of the Cooperative Cruise Control, user terminal 5 and ECU 6 of the motor-vehicle 1 are conveniently programmed to communicate through V2D and DV2 communication systems, without thereby preventing the Cooperative Cruise Control from being also implementable through a communication made through bidirectional wired communication systems.

To cooperate with ECU 6 in order to implement the Cooperative Cruise Control, a user terminal 5 should also be equipped with a software application (APP), shown in FIG. 3 with reference numeral 12, which can be either an APP specifically dedicated to the implementation of the Cooperative Cruise Control and downloadable from the main online APP stores, or the same APP that is part of automotive user interface 3 and provided by the automotive manufacturer to allow users to interact with automotive systems 2, and in which the Cooperative Cruise Control is also provided.

In particular, when installed and executed on a user terminal 5, the APP 12 is designed to cause the user terminal 5 to:
expose, i.e., display on an electronic display of the user terminal 5, a Graphical User Interface (GUI) designed to allow a user to activate the CC or ACC function according to the present invention,
provide processing and storage capacity to compute and store the Cruise Control data necessary for the implementation of the Cooperative Cruise Control, better described in detail below, and
communicate with ECU 6 through communication interfaces 4, 11 to transmit to the ECU 6 the Cruise Control data necessary for the implementation of the Cooperative Cruise Control.

ECU 6 is programmed to:
communicate with user terminal 5 through communication interfaces 4, 11 to receive the Cruise Control data computed and transmitted by user terminal 5, and
implement, based on the received Cruise Control data, the Cooperative Cruise Control according to the present invention.

To implement the Cooperative Cruise Control, the APP 12 is designed to cause, when executed, the user terminal 5 to implement a series of functions that can be logically grouped into three main categories:
recognizing and storing recurring paths or routes travelled by the motor-vehicle 1 manually driven by a specific driver,
for each of the recognized recurring paths or routes, learning and storing one or more driver-specific driving speed profiles, and
using of the stored driving speed profiles to implement the Cooperative Cruise Control of the present invention.

In particular, to recognize recurring paths or routes of the motor-vehicle 1, the APP 12 is designed to cause, when executed, the user terminal 5 to:
receive a command to start the Cooperative Cruise Control function given by the user through the automotive user interface 3 and represented, for example, by recognition of actuation of one of the function selection and activation buttons 9, or by recognition of a specific gesture performed by the user on one of the electronic displays 8, and
once the Cooperative Cruise Control is started, start acquiring and using geolocation data provided by the satellite geolocation device of the user terminal 5 to recognize recurring paths or routes of the motor-vehicle 1, on which the user terminal 5 is located, and travelled by the driver of the motor-vehicle 1 manually driven by the specific driver based on a recurring path recognition algorithm known in literature, for example the one used by Google Maps to identify the daily home-to-work commute and vice versa, or a proprietary recurring path recognition algorithm specifically developed by the automotive manufacturer to achieve certain performances in identification of recurrent paths or routes.

Recognition of recurring paths or routes can be performed in several ways.

In one embodiment, a recurring path or route can be recognized based on the geolocation data provided by the geolocation device of user terminal 5 by disseminating (defining), according to a proprietary or a known dissemination criterion, and storing a sequence of individual geographical positions along a path travelled by motor-vehicle 1 in the range of time between recurring path definition start and end commands imparted by the user through the graphical user interface displayed on the display of the user terminal 5, and then determining, at the disseminated geographic locations, associated travel directions or bearing or heading angles of the motor-vehicle 1.

In a different embodiment, a recurring path or route can be defined based on the geolocation data provided by the geolocation device of user terminal 5 by:
disseminating (defining), according to a proprietary or known dissemination criterion, and storing a sequence of individual geographical positions along a path travelled by motor-vehicle 1 during different trips or missions of the motor-vehicle 1, each defined as the period of time from a switching on and a subsequent switching off of the motor-vehicle 1 engine, always using geolocation data provided by the geolocation device of user terminal 5,
determining and storing values of a series of physical quantities, such as, for example, time and travel direction, which define attributes of the disseminated geographical positions, and
processing the attributes of the disseminated geographic positions associated to different trips or missions of the motor-vehicle 1 in order to suitably concatenate the disseminated geographic positions to form ordered lists of geographical positions belonging to associated recurring paths or routes.

By way of non-limiting example, geographical positions may be disseminated according to a dissemination criterion based on elapsed time and distance travelled from the previous disseminated geographical position and the curvature of the path, so that the disseminated geographical positions are less dense along straight sections of the path and denser along bends, in order to improve precision of the definition of the recurring paths or routes.

To learn driver-specific driving speed profiles of the motor-vehicle 1 along recognized recurring paths or routes, the APP 12 is designed to cause, when executed, the user terminal 5 to determine, based on data provided by the sensory system of the motor-vehicle 1, and store a driving speed of the motor-vehicle 1 at each geographical position disseminated along the recurrent paths or routes of the motor-vehicle 1 and whenever motor-vehicle 1 is driven across the geographical position, thus forming, for each disseminated geographical position, a collection of driving speeds, whose cardinality is suitably defined to cause the collection of driving speeds to be statistically significant in terms of driving speed variability at the disseminated geographical location.

Conveniently, the cardinality of the driving speed collection associated with each disseminated geographic location is odd and, by way of non-limiting example, it could be equal to eleven, i.e., each driving speed collection associated with a disseminated geographical position comprises eleven different driving speeds.

The set of driving speeds associated with the individual speed collections but learnt when the motor-vehicle 1 is driven along one and the same recurring path, define an associated driving speed profile of the motor-vehicle 1 along the recurring path.

In order to use the stored driving speed profiles to implement the Cooperative Cruise Control, in one embodiment the APP 12 is designed to cause, when executed, the user terminal 5 to:
determine the current geographical position of the motor-vehicle 1 based on the geolocation data provided by the satellite geolocation device of the motor-vehicle 1,
compare the current geographical position of the motor-vehicle 1 with the disseminated geographical positions at which the driving speed collections are stored;
when the current geographical position of the motor-vehicle 1 corresponds to one of the disseminated geographical positions, determine, based on the driving speeds in the collection of driving speeds associated with the current geographical position of the motor-vehicle 1, a driving speed to be used as a cruise speed of the motor-vehicle 1 in the current geographical position of the motor-vehicle 1, and
finally transmit the determined driving speed to the ECU 6, through communication interfaces 4, 11.

ECU 6 is programmed to:
receive the driving speed transmitted by user terminal 5, and
use the received driving speed as the cruise speed of the motor-vehicle 1 to implement the CC or ACC function.

Conveniently, but not necessarily, in one embodiment the APP 12 is designed to cause the user terminal 5 to determine the driving speed to be used as the cruise speed of the motor-vehicle 1 in the current geographical position of the motor-vehicle 1 simply by selecting one specific driving speed from within the associated collection of driving speeds associated with the current geographical position of the motor-vehicle 1.

Conveniently, but not necessarily, in one embodiment the APP 12 is designed to cause the driving speed selected from within the collection of driving speeds associated with the current geographical position of the motor-vehicle 1 to be the median driving speed in the collection of driving speeds.

To do this, the APP 12 is therefore designed to cause the user terminal 5 to sort the driving speed collection associated with the current geographical position of the motor-vehicle 1 in either increasing or decreasing order of driving speeds, so as to form an ordered list of driving speeds, and then select the median driving speed from within the ordered list of driving speeds.

It goes without saying that it is possible to adopt other criteria for selecting the driving speed from within the collection of driving speeds, as well as it is possible to adopt other criteria for determining the driving speed to be used as the cruise speed of the motor-vehicle 1 in the current geographical position of the motor-vehicle 1.

By way of non-limiting example only, the driving speed to be used as the cruise speed of the motor-vehicle 1 in the current geographical position of the motor-vehicle 1 could be computed as a function of the driving speeds belonging to the collection of driving speeds, based on an intelligent learning algorithm based on Machine Learning techniques developed by the automotive manufacturer in order to achieve distinctive performances in terms of driving experience or comfort compared to those of other automotive manufacturers.

In a different embodiment, the APP 12 is designed to cause the user terminal 5 to:
recognize the recurring path or route travelled by the motor-vehicle 1 when manually driven by the specific driver, based on geolocation data provided by the satellite geolocation device of the motor-vehicle 1,
determine, based on the driving speed profiles stored in association with the recurring path or route of the motor-vehicle 1, speed profile to be used as the cruise speed profile of the motor-vehicle 1 along the recurring path or route of the motor-vehicle 1, and
finally transmit the driving speed profile thus determined to ECU 6, through communication interfaces 4, 11.

ECU 6 is programmed to:
receive the driving speed profile transmitted by user terminal 5,
use the received driving speed profile as the cruise speed profile of the motor-vehicle 1 in implementing the CC or ACC function.

In order to use the received driving speed profile as the cruise speed profile of the motor-vehicle 1 in implementing the CC or ACC function, ECU 6 is programmed to:
determine the current geographical position of the motor-vehicle 1 based on the geolocation data provided by the satellite geolocation device of the motor-vehicle 1,
identify, within the received driving speed profile, the driving speed associated with the current geographical position of the motor-vehicle 1, and
use the identified driving speed as the cruise speed of the motor-vehicle 1 in implementing the CC or ACC function.

Conveniently, but not necessarily, in one embodiment the APP 12 is designed to cause the user terminal 5 to determine the driving speed profile to be used as the cruise speed profile of the motor-vehicle 1 along the recurring path or route of the motor-vehicle 1 similarly to that previously described for the previous embodiment, i.e., by simply selecting specific driving speed speeds in the driving speed collections associated with the geographical locations disseminated along the recurring path or route of the motor-vehicle 1.

Conveniently, but not necessarily, also in this embodiment the APP 12 is designed to cause the driving speed speeds selected in the driving speed collections associated with the disseminated geographical locations along the recurring path of the vehicle 1 to be the median driving speeds in the driving speed collections, and to do this, the APP 12 is therefore designed to cause the user terminal 5 to sort the driving speed collections associated with the disseminated geographical positions along the recurring path or route of the motor-vehicle 1 either in ascending or descending order of driving speed, so as to form associated ordered lists of driving speeds, and then select the median driving speeds in the ordered lists of driving speeds.

It goes without saying that also in this embodiment it is possible to adopt other criteria for selecting or determining the individual driving speeds which form the driving speed profile to be used as the cruise speed profile of the motor-vehicle 1 along the recurrent path or route of the motor-vehicle 1, for example selection or determination criteria similar to those previously described for the previous embodiment.

Finally, to learn a driver-specific driving speed profile of the motor-vehicle 1, the APP 12 is designed to initially identify the motor-vehicle driver who is manually driving the motor-vehicle 1 along the path or route.

For this purpose, the APP 12 is designed to initially identify the driver of the motor-vehicle 1 based on one or different quantities indicative of the identity of the driver and provided by one or different sources of information on the identity of the driver and conveniently including one or more of the following:
an automotive infotelematic system with which the driver's smartphone is paired when the driver is the passenger compartment of the motor-vehicle 1, the pairing occurring, as is known, following a pairing procedure during which smartphone identifier is recognized,
an automotive satellite navigator, through which it is possible to recognize the driver based on his usual paths,
the automotive user interface 3, which can be programmed to invite the driver to identify himself/herself once he/she starts driving the motor-vehicle 1, and
a driver recognition feature operating based on the driver's driving style, which can be computed based on dynamic quantities of the motor-vehicle 1 measured by a sensory system of the motor-vehicle 1 and indicative of the driver's driving style, such as, conveniently, longitudinal speed, lateral acceleration, and yaw rate of the motor-vehicle 1.

Based on what has been described above, the advantages that the present invention allow to achieve may be appreciated.

In particular, the present invention allows implementation of CC and ACC functions whose behavior in adjusting the driving speed of the motor-vehicles is in line with the driving habits of the drivers of the motor-vehicles along recurrent paths or routes, thus improving the driving experience or comfort compared to prior art solutions.

1. An automotive electronic driving speed control system for a motor-vehicle, characterized by being configured to control the driving speed of the motor-vehicle along a recurring path travelled by the motor-vehicle in autonomous-driving based on one or more driver-specific driving speed profiles of the motor-vehicle learnt during one or more previous travels of the same path along which the motor vehicle is manually driven by the specific driver.

2. The automotive electronic driving speed control system of claim 1, further configured to learn one or more driver-specific driving speed profiles of the motor-vehicle during one or more previous travels along which the motor vehicle is manually driven by the specific driver and/or to communicate with a user terminal present on board the motor-vehicle to receive from the user terminal one or more driver-specific driving speed profiles of the motor-vehicle learnt by the user terminal during one or more previous travels of the same path along which the motor vehicle is manually driven by the specific driver.

3. The automotive electronic driving speed control system of claim 2, wherein either the automotive electronic driving speed control system or the user terminal is further configured to learn a driver-specific driving speed profile along a recurring path of the motor-vehicle along which the motor vehicle is manually driven by the specific driver by:
recognizing a recurring path of the motor-vehicle, and
storing driving speeds of the motor-vehicle at different geographical locations along the recognized recurring path of the motor-vehicle.

4. The automotive electronic driving speed control system of claim 3, wherein either the automotive electronic driving speed control system or the user terminal is further configured to learn a driver-specific driving speed profile along a recurring path of the motor-vehicle along which the motor vehicle is manually driven by the specific driver by:
storing, at each geographical location along the recurring path of the motor-vehicle, different driving speeds of the motor-vehicle, one each time the motor-vehicle is manually driven by the specific driver along the recurring path, thereby forming, for each of geographical location, an associated collection of driving speeds;
and wherein the automotive electronic driving speed control system is further configured to control the driving speed of the motor-vehicle along a recurring path travelled by the motor-vehicle in autonomous-driving based on the driving speed collections of the motor-vehicle stored at the different geographical locations along the recurring path.

5. The automotive electronic driving speed control system of claim 4, wherein either the automotive electronic speed control system or the user terminal is further configured to:
determine specific driving speeds of the motor-vehicle at the different geographical locations along a recurring path of the motor-vehicle based on the associated driving speed collections associated with the geographical locations;
and wherein the automotive electronic driving speed control system is further configured to control the driving speed of the motor-vehicle along a recurring path travelled by the motor-vehicle in autonomous-driving based on the specific driving speeds determined at the different geographical locations along the recurring path.

6. The automotive electronic driving speed control system of claim 5, wherein either the automotive electronic speed control system or the user terminal is further configured to determine specific driving speeds of the motor-vehicle at different geographical locations along a recurring path of the motor-vehicle by selecting the specific driving speeds from within the associated driving speed collections stored at the different geographical locations.

7. The automotive electronic driving speed control system of claim 6, wherein either the automotive electronic speed control system or the user terminal is further configured to select specific speeds from within the driving speed collections stored at the different geographical locations by sorting the driving speed collections in either ascending or descending order of driving speeds, and then selecting the median driving speeds in the associated speed collections.

8. The automotive electronic driving speed control system of claim 4, wherein the user terminal is further configured to:
transmit to the automotive electronic driving speed control system the determined specific driving speeds of the motor-vehicle;
and wherein the automotive electronic driving speed control system is further configured to:
receive from the user terminal the specific driving speeds of the motor-vehicle, and
control the driving speed of the motor-vehicle along a recurring path travelled by the motor-vehicle in autonomous-driving based on the received specific driving speeds.

9. The automotive electronic driving speed control system of claim 8, wherein the user terminal is further configured to:
recognize if a current path travelled by the motor-vehicle is a recurring path, and
in the affirmative, communicate with the automotive electronic driving speed control system to transmit the driving speeds of the motor-vehicle stored along the recognized recurring path of the motor-vehicle;
and wherein the automotive electronic driving speed control system is further configured to:
receive from the user terminal the driving speeds of the motor-vehicle along the recurring path of the motor-vehicle, and
control the driving speed of the motor-vehicle along the recurring path travelled by the motor-vehicle in autonomous-driving based on the received driving speeds of the motor-vehicle.

10. (canceled)
